(19) United States
(12) Patent Application Publication
(10) Pub. No.: US 2006/0103231 A1
(43) Pub. Date: May 18, 2006

(54) Bicycle wheel

(76) Inventor: Moreno Fioravantil, Ozzano dell'Emilla (IT)

Correspondence Address: REED SMITH LLP, 3110 FAIRVIEW PARK DRIVE, SUITE 1400, FALLS CHURCH, VA, 22042, US

(21) Appl. No.: 10/531,296

(22) PCT Filed: Oct. 30, 2003
(86) PCT No.: PCT/EP03/12103

§ 371 Date: Oct. 31, 2005

(30) Foreign Application Priority Data
Nov. 6, 2002 (IT) BO2002A00700
May 6, 2003 (IT) BOV0048

(51) Int. Cl. B60B 1/02

(52) U.S. Cl. 301/55

(57) ABSTRACT

A bicycle wheel, in particular for racing and mountain bicycles, is provided which comprises a hub and a rim connected with by means of a plurality of radial elements. The radial elements are grouped in a first distribution, in which said elements are arranged on one side of the wheel, and a second distribution, in which said elements are arranged on the other side of the wheel, said first and second distribution connecting said rim to respective ends of said hub. The radial elements of said first distribution are connected to said rim in respective fixing seats which are disposed alternate, along said rim, to the fixing seats of the radial elements of said second distribution.

The present invention relates to a bicycle wheel, particularly for racing and mountain bicycles.

In the field of bicycle manufacturing, particularly racing bicycles and bicycles for excursions on rough and mountain terrain, wheels are known in which the hub is connected to the rim by virtue of a plurality of wire spokes, having various shapes and dimensions, and variously arranged.

Along the rim of such wheels is provided a regular distribution of fixing elements to the wire spokes, for instance nipples, which are mutually angularly equidistant by a preset angle. In conventional wheels these nipples are coupled alternatively to the first or to the second hub flange, so that the wire spokes cross each other regularly.

Nevertheless, wheels are recently been provided which are monolithically formed by pressure die-casting, and in which the hub and the rim are manufactured in a single body and are connected by virtue of a distribution of radial elements, for instance spokes or arms having various profiles and cross sections. Wire spoke wheels and monolithic wheels have different functional characteristics (rigidity, mechanical strength, life time, streamline), which direct users' choice according to their necessities, preferences and needs. As a matter of fact, wire spokes wheels can offer the great advantage of low weight, but can't have the same performances of monolithic wheels in terms of rigidity, mechanical strength and streamline.

The present invention aims to provide a wheel, in particular for racing and mountain bicycle, which allows to obtain the typical mechanical and dynamical behavior of monolithic wheels combined with a low weight.

This aim is achieved by the present bicycle wheel, particularly for racing and mountain bicycle, which comprises a hub and a rim connected therewith by means of a plurality of radial elements, wherein said radial elements are grouped in a first distribution, in which said elements are arranged on one side of the wheel, and a second distribution, in which said elements are arranged on the other side of the wheel, said first and second distribution being designed to connect said rim to a respective end of said hub, the radial elements of said first distribution being fixed to said rim at respective fixing seats which are disposed alternate to the fixing seats of the radial elements of said second distribution along said rim

Advantageous embodiments of the invention are characterized in the sub-claims.

The present invention provides a versatile wheel, suitable for different needs and designs as to mechanical and appearance features. The present invention also achieves a wheel being simple, relatively easy to provide in practice, safe in use, effective in operation and relatively modest in cost.

A preferred but not exclusive embodiment of a bicycle wheel, particularly for racing and mountain bicycle, will now be described which is illustrated only by way of non limiting example in the accompanying drawings, wherein:

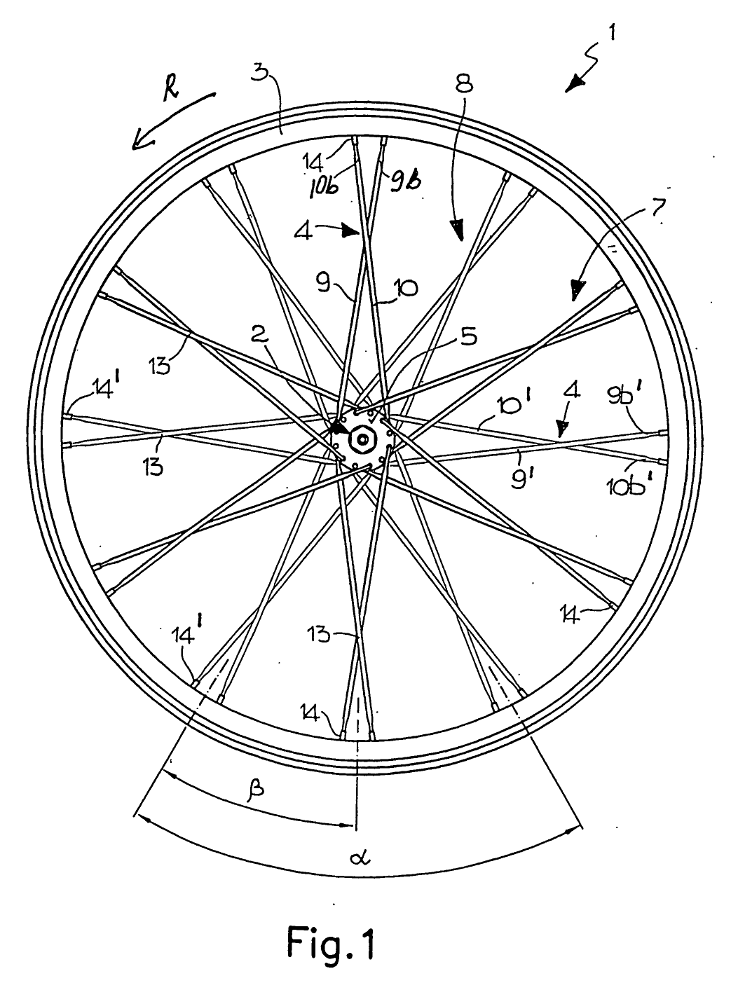

FIG. 1 is a lateral elevation view of the wheel according to the invention;

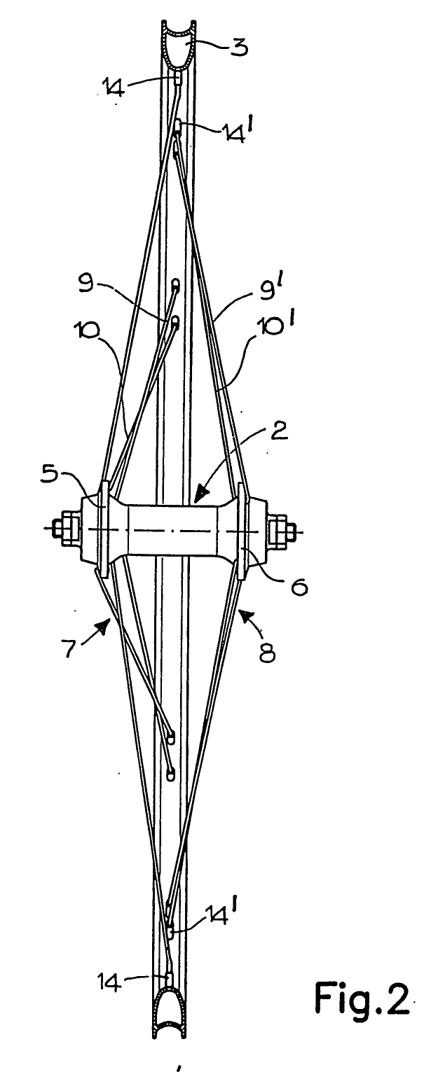

FIG. 2 is a diagonal sectional view of the wheel;

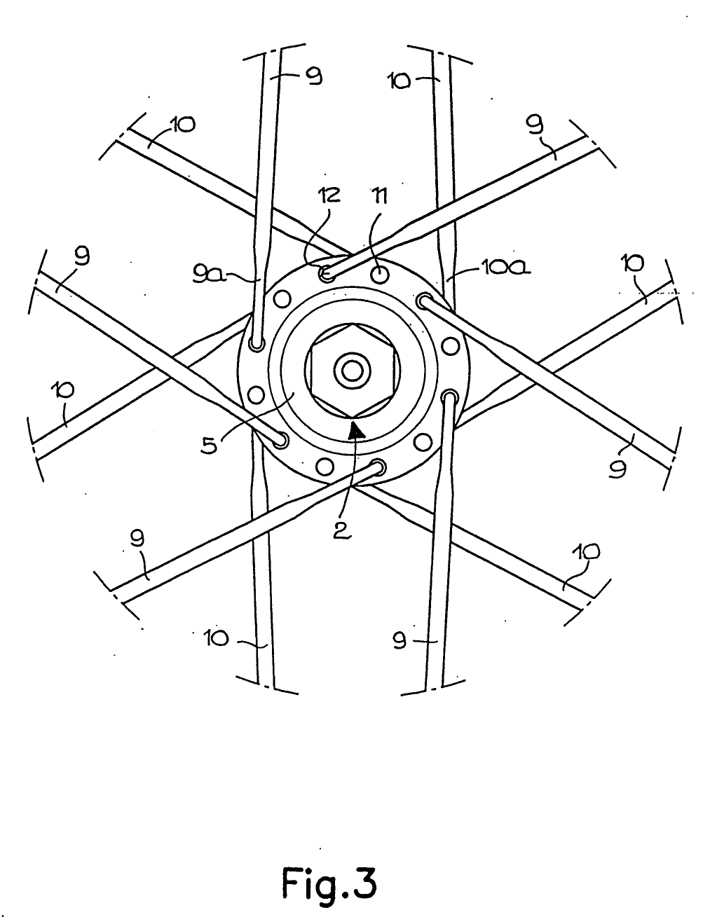

FIG. 3 is a detailed lateral elevation view of the wheel;

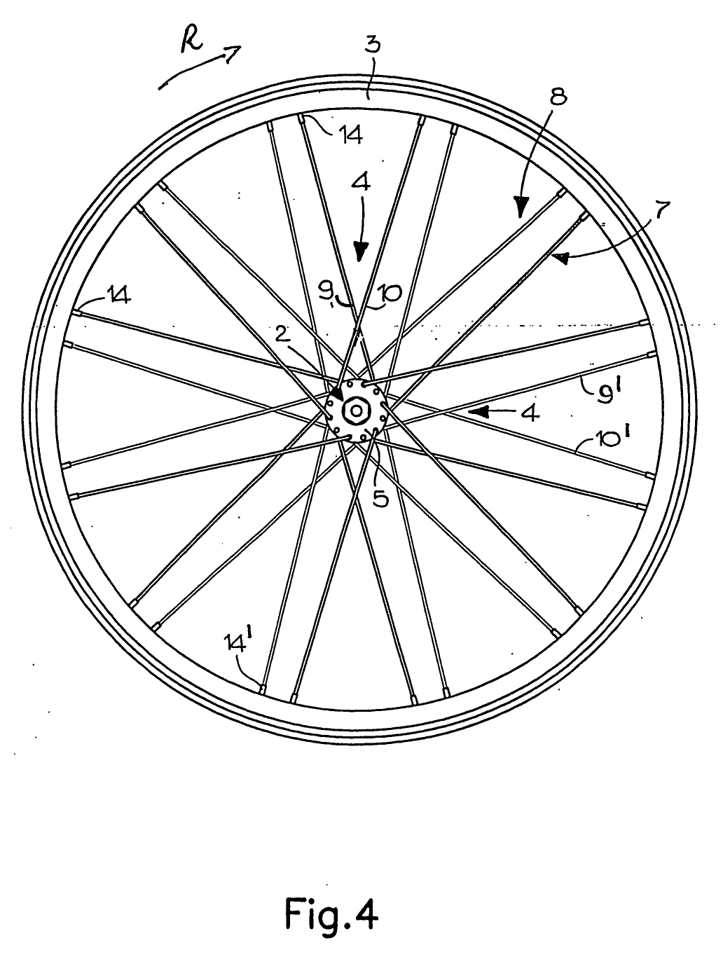

FIG. 4 is a lateral elevation view of an embodiment of the wheel;

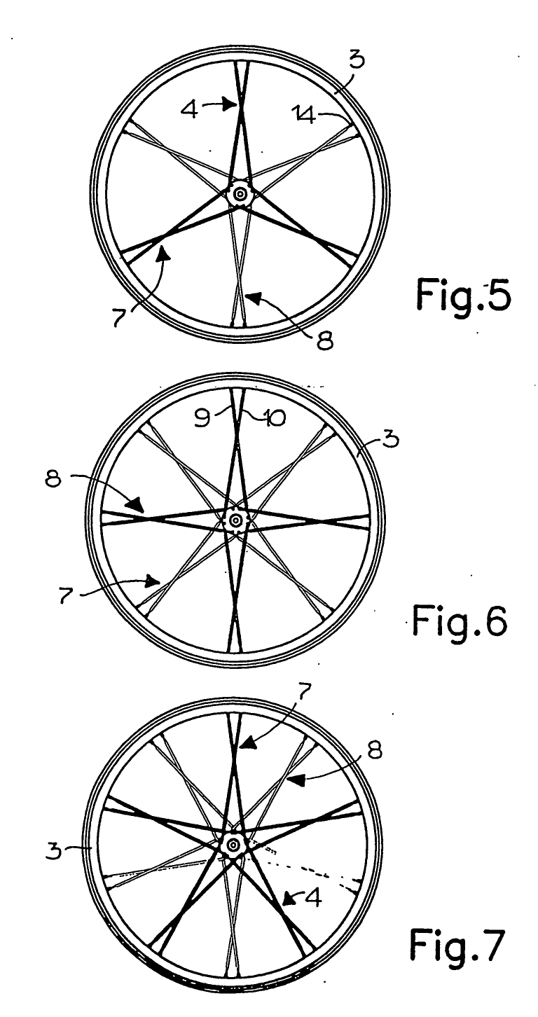

FIG. 5, 6, 7 are lateral elevation views of respective embodiments of the wheel, having different number of radial elements;

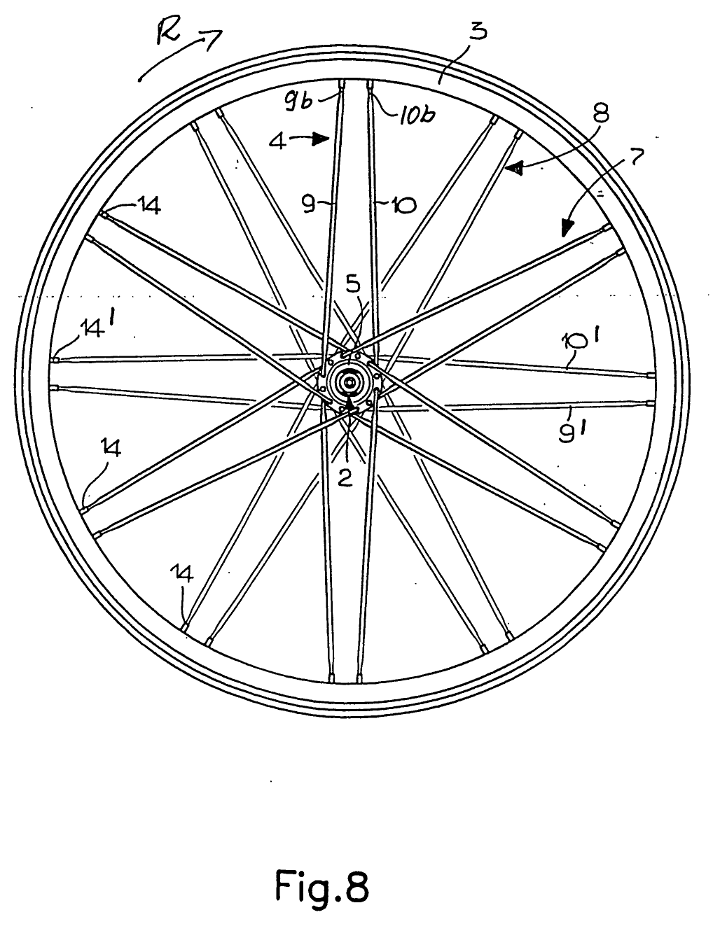

FIG. 8 is a lateral elevation view of a first alternative embodiment of the wheel;

FIG. 8a is a lateral elevation view of a different embodiment of the wheel of FIG. 8;

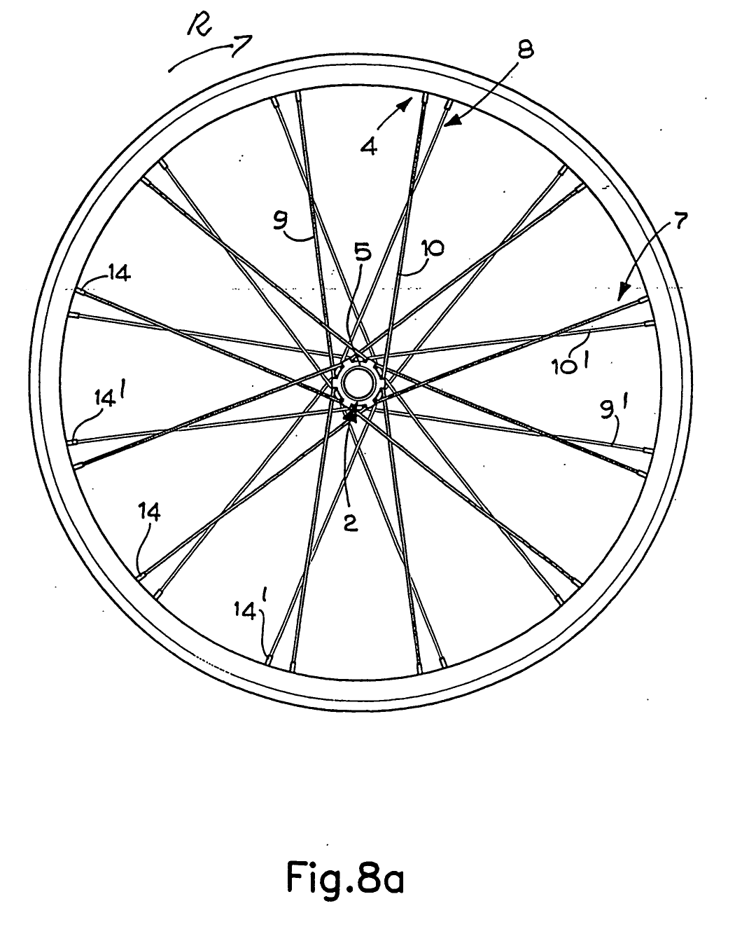

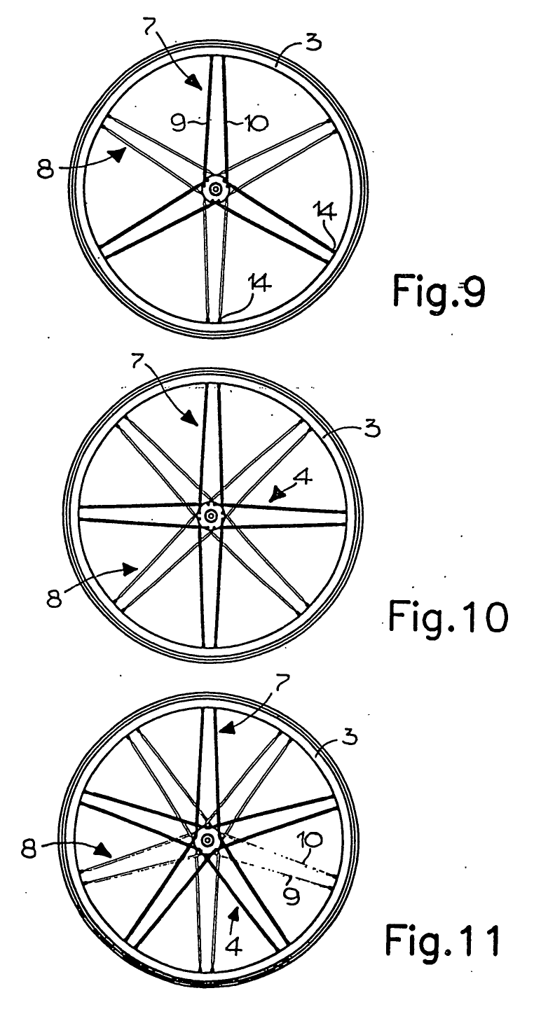

FIG. 9, 10, 11 are lateral elevation views of different embodiments of the wheel of FIG. 8, having different number of radial elements;

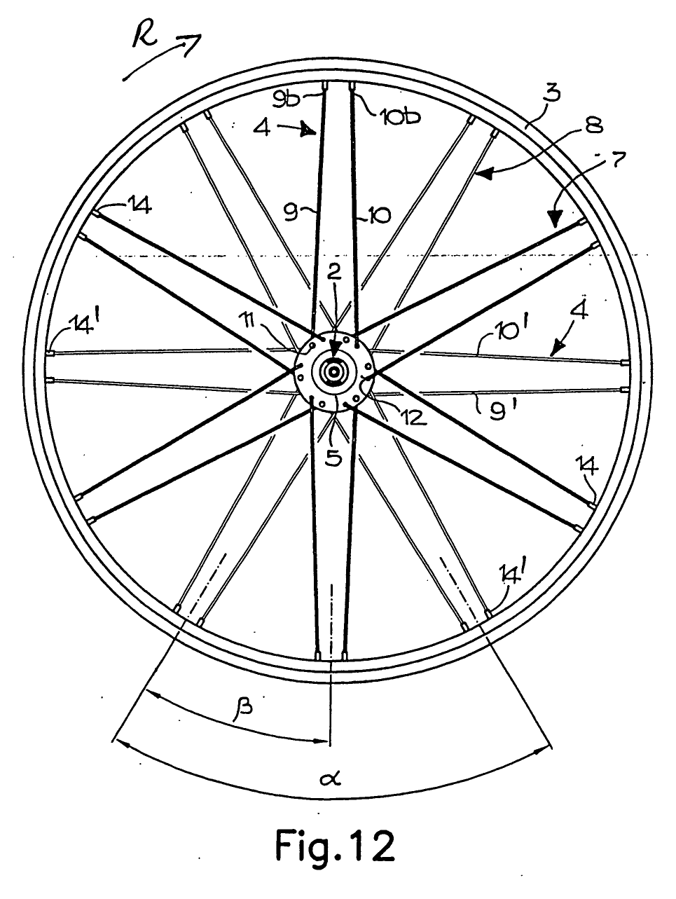

FIG. 12 is a lateral elevation view of a second alternative embodiment of the wheel;

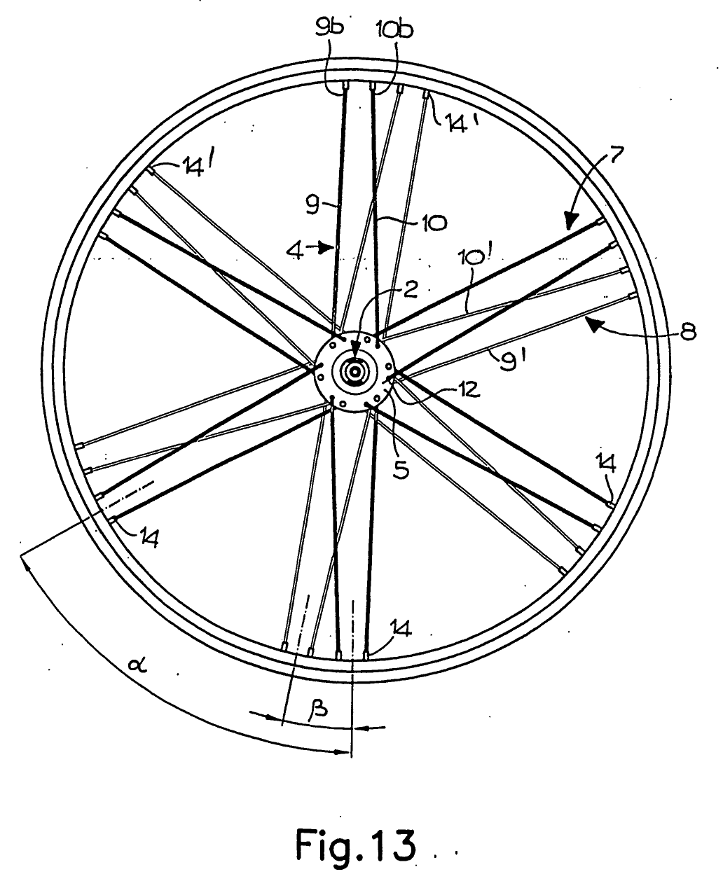

FIG. 13 is a further embodiment of the wheel of FIG. 12;

FIG. 14 is a lateral elevation view of a third alternative embodiment of the wheel;

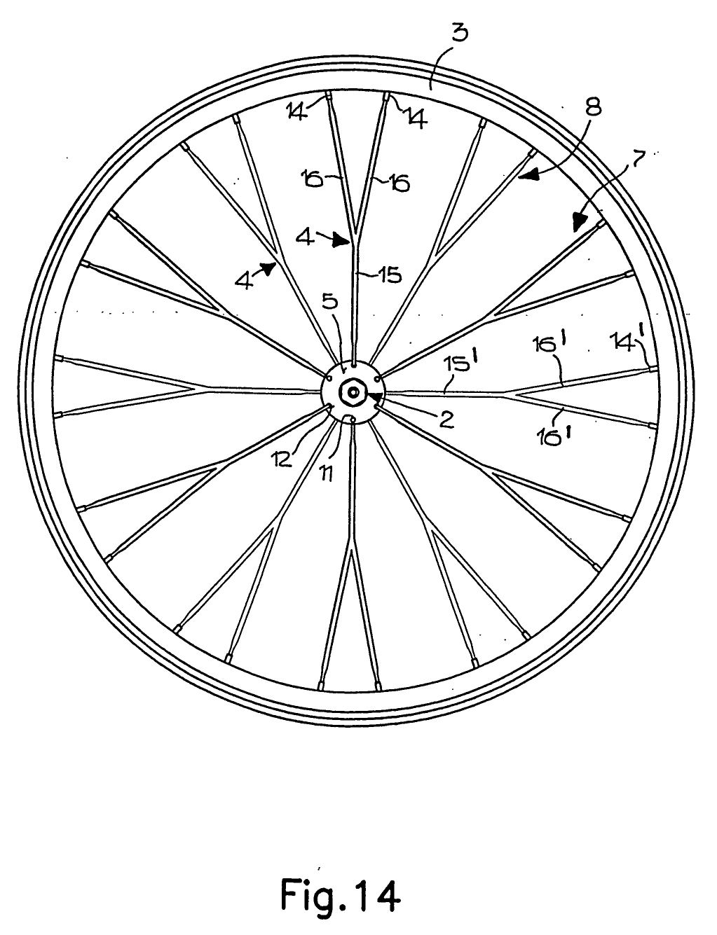

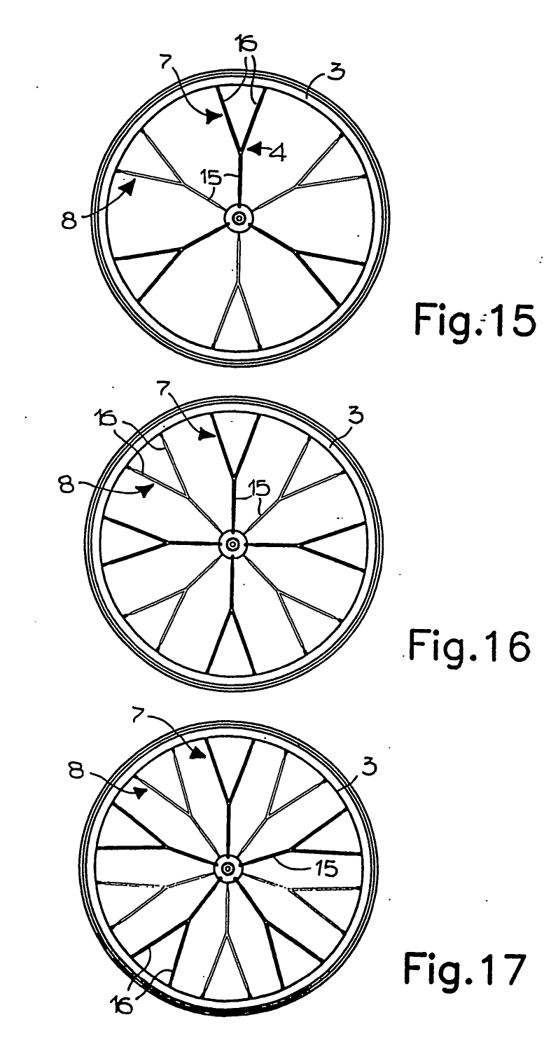

FIG. 15, 16, 17 are lateral elevation views of different embodiments of the wheel of FIG. 14, having different number of radial elements.

With particular reference to the Figures cited above, the reference numeral 1 generally designates a bicycle wheel particularly for a racing and mountain bicycle according to the invention.

The wheel comprises a hub 2 and a rim 3 which are coaxial and connected by means of a plurality of radial elements 4. As shown in FIG. 2, the hub 2 has two opposite ends where a first disc-shaped flange 5 and a second disc-shaped flange 6 are provided, respectively. The radial elements 4 engage the disc-shaped flanges 5,6.

According to the invention, the radial elements 4 are grouped in a first distribution 7 on one side of the wheel and in a second distribution 8 on the other side of the wheel. The first distribution 7 and the second distribution 8 are arranged in such a way to connect, respectively, the first and the second flanges 5, 6 of the hub 2 to the rim 3.

Each of the radial elements 4 of the first distribution 7 is constituted by a first wire spoke 9 and a second wire spoke 10, having respective proximal terminal portions 9a, 10a engaged to the first flange 5 of the hub 2, and respective distal terminal portions 9b, 10b, engaged in respective couples of contiguous fixing seats 14 of the rim 3.

Each of the radial elements 4 of the second distribution 8 is constituted correspondingly by a first wire spoke 9′ and a second wire spoke 10′, having respective proximal terminal portions 9a′, 10a′ engaged to the second flange 6 of the hub 2, and respective distal terminal portions 9b′, 10b′ engaged in respective couples of contiguous fixing seats 14′ of the rim 3.

The spokes of one radial element 4 are, by definition, spokes connected to one and the same flange 5 or 6. In other words, if one spoke, for example spoke 9, of one radial element 4 is connected to flange 5, the other spoke 10 of this radial element may not originate from the other flange 6.

Each wire spoke 9, 9′, 10, 10′ has, in their terminal portions 9a, 9a′, 10a, 10a′ a head 11 which engage in a respective holes 12 provided in the first and second flanges 5, 6 of the hub 2. Preferably, these heads 11 are connected alternatively to internal and the external surface of the flange 5, 6, for a better balance of the wheel.

The radial elements 4 of the first distribution 7 and the radial elements 4 of the second distribution 8 are, preferably, mutually angularly equidistant by a first preset angle α In FIG. 1, 2, 3 each of the first and the second distribution 7, 8 have for instance six radial elements 4 which means that the first preset angle α is 60°.

The radial elements 4 of the first distribution 7 are offset respect to the radial elements 4 of the second distribution 8 by a second preset angle β; preferably this second preset angle β is half of the first preset angle α, so the fixing seats to the rim 3 of the first and the second distribution 7,8 are regularly alternate along the internal side of the rim. The second preset angle β may assume different values depending on the needs.

The respective fixing seats 14, 14′ are mutually alternately arranged along the rim. The mutual distance between the seats 14 or 14′ of one radial element 4 may assume different values as will be explained with respect to the embodiments below. The pairs of seats 14 or 14′ are arranged mutually angularly equidistant along the rim 3 by the second preset angle β. The fixing seats 14, 14′ may comprise nipples , rigidly coupled to the internal side of the rim 3 and protruding radially towards the wheel axis, to connect the radial elements or the wire spokes 9,10; 9′, 10′, respectively, of the first and second distributions 7, 8 respectively to the first and the second flanges 5, 6 of the hub 2. Each nipple may have an internal thread into which terminal threaded portions 9b, 9b′, 10, 10b′ of the spokes 9, 9′, 10, 10′ engage.

The arrangement of the first and second distributions 7, 8 of radial elements 4 is meant to simulate the dynamical behavior of the arms of a monolithic wheel. However, the distance between the seats of a pair of spokes and the distance between the seats of different pairs of spokes may be varied to achieve various design or appearance effects while keeping the mechanical stability of the wheel. The distributions 7, 8 of spokes 9, 9′, 10, 10′ on both sides of the wheel connected to the rim by couples of nipples in the seats 14 are mutually alternating which confers the dynamical behavior of a monolithic wheel to the wheel according to the invention in terms of rigidity and mechanical strength; at the same time the wheel has a low weight.

In use, the behavior of radial elements 4 comprising pairs of spokes 9, 10, functionally simulates the properties of the spokes typically provided in monolithic-type wheels as long as the forces exerted by the spokes to the rim are balanced within the distributions of the radial elements (on one side each of the wheel) and between the two distributions of the radial elements (from one side to the other). Moreover, radial elements providing the same characteristics as obtained in monolithic wheels are obtained through more economic processes and require a lower amount of material.

As shown in FIG. 1, the first and the second wire spoke 9, 10 of each radial element 4 are coupled to their fixing seats so that they cross each other, and they are in mutual contact with each other at crossing points 13.

In the embodiment of FIGS. 1, 2, 3 showing a wheel having six radial elements 4 for each distribution 7, 8, twelve holes 12 are, for instance, arranged along the periphery of each flange 5, 6 and are mutually angularly equidistant. The wire spokes 9, 10 of a radial element 4 are anchored in holes 12 which are five holes apart as can be seen in FIG. 3. Of the seats for one pair of spokes 9, 10 of a radial element 4, the seat of the spoke 9 in the rim is, in the running direction R of the wheel, behind the seat of the spoke 10 in the rim, and the anchoring hole of the spoke 9 in the flange of the hub is, in the running direction R of the wheel, in front of the anchoring hole of the spoke 10 in the flange of the hub. Therefore, the spokes 9, 10 cross on their way from the flanges 5,6 to the rim 2. In general, for wheels having a high number of radial elements, the spokes 9, 10 are engaged in the holes 12 so that the first spoke 9 of each odd element 4 (first, third, fifth) cross with the second spoke 10 of the odd element immediately preceding; in the same way, the first spoke 9 of each even element 4 (second, fourth, sixth) cross with the second spoke 10 of the even element immediately preceding.

FIG. 4 shows an embodiment where the distance between the seats of a pair of spokes 9, 10 forming a radial element 4 is relatively large which give the wheel a distictly different appearance. The wheel again has six radial elements 4 for each distribution 7, 8, and twelve holes 12 are, for instance, arranged along the periphery of each flange 5, 6 and are mutually angularly equidistant. The wire spokes 9, 10 of a radial element 4 are anchored in holes 12 which are three holes apart as can be seen in FIG. 4. Of the seats for one pair of spokes 9, 10 of a radial element 4, the seat of the spoke 9 in the rim is, in the running direction R of the wheel, behind the seat of the spoke 10 in the rim, and the anchoring hole of the spoke 9 in the flange of the hub is, in the running direction R of the wheel, in front of the anchoring hole of the spoke 10 in the flange of the hub. Therefore, the spokes 9, 10 cross on their way from the flanges 5,6 to the rim 2.

FIGS. 5, 6, 7 shown further embodiments of the wheel according to the. invention. These embodiments have different numbers of radial elements 4 for each distribution 7, 8. The embodiment of FIG. 5 has three radial elements (uniformly angularly spaced from each other through a first angle α of 120 degrees) for each distribution; the embodiment of FIG. 6 is provided with four radial elements angularly spaced apart through a right angle for each distribution. In the embodiment of FIG. 7 the wheel has five radial elements for each distribution.

In FIG. 8 a first alternative embodiment of the wheel is shown, in which the wheel is provided with six radial elements 4 in each distribution 7, 8 and in which the first and the second spoke 9, 10 of each element are slightly convergent toward the seats 14. The wheel again has six radial elements 4 for each distribution 7, 8, and twelve holes 12 are, for instance, arranged along the periphery of each flange 5, 6 and are mutually angularly equidistant. The wire spokes 9, 10 of a radial element 4 are anchored in holes 12 which are five holes apart as can be seen in FIG. 8. Of the seats 14 for one pair of spokes 9, 10 of a radial element 4, the seat of the spoke 9 in the rim is, in the running direction R of the wheel, behind the seat of the spoke 10 in the rim, and the anchoring hole of the spoke 9 in the flange of the hub is, in the running direction R of the wheel, also behind the anchoring hole of the spoke 10 in the flange of the hub. Therefore, the spokes 9, 10 do not cross on their way from the flanges 5,6 to the rim 2.

In the embodiment of FIG. 8a, the first and the second spokes 9, 10 of a radial element 4 are slightly divergent. The wheel again has six radial elements 4 for each distribution 7, 8, and twelve holes 12 are arranged along the periphery of each flange 5, 6 and are mutually angularly equidistant. The wire spokes 9, 10 of a radial element 4 are anchored in holes 12 which are five holes apart as can be seen in FIG. 8a. Of the seats 14 for one pair of spokes 9, 10 of a radial element 4, the seat of the spoke 9 in the rim is, in the running direction R of the wheel, behind the seat of the spoke 10 in the rim, and the anchoring hole of the spoke 9 in the flange of the hub is, in the running direction R of the wheel, also behind the anchoring hole of the spoke 10 in the flange of the hub. Therefore, the spokes 9, 10 of one radial element 4 do not cross on their way from the flanges 5,6 to the rim 2. However, due to the spread or divergent arrangement of the spokes 9, 10 of one radial element 4, the appearance of the wheel as viewed from the side is similar to the appearance of the wheel of FIG. 1.

FIGS. 9, 10, 11 show further embodiments of the wheel of FIG. 8. In these embodiments the wheel is provided respectively with three (FIG. 9), four (FIG. 10) and five (FIG. 11) radial elements for each distribution 7, 8.

FIG. 12 shows a second alternative embodiment of the wheel, with six radial elements 4 for each distribution 7, 8 and with spokes 9, 10 slightly convergent. This wheel is provided with a hub with flanges 5, 6 having an lager diameter. The spokes are engaged in the holes 12 in such a way that, for each distribution 7, 8 of radial elements 4, a simple crossing of the first spoke 9 of each element is obtained close to the flanges 5, 6 with the second spoke 10 of an element immediately adjacent thereto. The number of radial elements provided in the wheel of FIG. 12, may be varied.

The wheel of FIG. 12 has six radial elements 4 for each distribution 7, 8, and twelve holes 12 are arranged along the periphery of each flange 5, 6 and are mutually angularly equidistant The wire spokes 9, 10 of a radial element 4 are anchored in holes 12 which are three holes apart, as can be seen in FIG. 12. Of the seats 14 for one pair of spokes 9, 10 of a radial element 4, the seat of the spoke 9 in the rim is, in the running direction R of the wheel, behind the seat of the spoke 10 in the rim,. and the anchoring hole of the spoke 9 in the flange of the hub is, in the running direction R of the wheel, also behind the anchoring hole of the spoke 10 in the flange of the hub. Therefore, the spokes 9, 10 of one radial element 4 do not cross on their way from the flanges 5,6 to the rim 2.

The embodiment of FIG. 13 shows that, as mentioned above, the second predetermined angle β can be different from half of the first preset angle β. In the illustrated embodiment the second preset angle β is less than half the first preset angle α.

In the embodiments shown in FIGS. 8-13 the first and the second spoke 9, 10 of each radial elements 4 may be substantially parallel, and held in position by anchoring seats 14 (nipples) arranged no longer in pairs but substantially uniformly angularly spaced from each other, while still achieving the same technical effect.

FIG. 14 shows a third alternative embodiment of the wheel, in which each radial element 4 of each distribution 7, 8 presents substantially a Y-shaped conformation, with an end 15, 15′ engaging in the flanges 5 or 6 (for instance with a head 11) and two segments 16, 16′ having threaded terminal portions engaging in respective seats 14, 14′. FIGS. 15, 16, 17 show respective embodiments of the wheel of FIG. 14, with three, four and five radial elements for each distribution. The third alternative embodiment of the above described wheel (FIGS. 14, 15, 16, 17) has a decisively lower weight as compared to the previous embodiments, and a quite high stiffness.

The invention thus conceived is susceptible of numerous modifications and variations within the scope of the invention. Thus, it should be noted that the spokes 9, 10 in the above described embodiments can have any desired shape, dimensions, and geometry. In practice, the materials used in the wheel, as well as the shapes and the dimensions, may be any according to the requirements. In the examples of embodiment above, individual features, presented in relation to specific examples, may actually be interchanged with features that exist in other embodiments.

1. Bicycle wheel, in particular for racing and mountain bicycles, which comprises a hub and a rim connected with by means of a plurality of radial elements, wherein said radial elements are grouped in a first distribution, in which said elements are arranged on one side of the wheel, and a second distribution, in which said elements are arranged on the other side of the wheel, said first and second distribution connecting said rim to respective ends of said hub, the radial elements of said first distribution being connected to said rim in respective fixing seats which are disposed alternate to the fixing seats of the radial elements of said second distribution along said rim.

2. The wheel according to claim 1, wherein the radial elements of said first distribution and the radial elements of said second distribution are mutually angularly equidistant on each side of a wheel, by a first preset angle α, and wherein the elements of said first distribution being offset by a second preset angle β with respect to said first distribution.

3. The wheel according to claim 2, wherein said second preset angle β is half of said first preset angle α.

4. The wheel according to claim 1, wherein each of said radial elements is constituted by a first and a second wire spoke having respective terminal proximal portions connected to said hub and respective terminal distal portions connected to said rim in respective pairs of said fixing seats.

5. The wheel according to claim 4, wherein first and second spoke of one radial element cross each other.

6. The wheel according to claim 4, wherein said first and second spoke of one radial element are slightly convergent toward said couple of fixing seats.

7. The wheel according to claim 4, wherein said first and second spoke of one radial element are substantially parallel.

8. The wheel according to claim 4, wherein said first and second spoke of one radial element are slightly divergent toward said couple of fixing seats.

9. The wheel according to claim 1, wherein each of said radial elements is substantially Y-shaped, having an end engaged in said hub and two segments that are divergent and connected with respective couples of said fixing seats.

10. The wheel according to claim 1, wherein said fixing seats are constituted by nipples rigidly coupled to said rim and having an internal thread in which engage said spokes.

11. The wheel according to claim 2, wherein each of said radial elements is constituted by a first and a second wire spoke having respective terminal proximal portions connected to said hub and respective terminal distal portions connected to said rim in respective pairs of said fixing seats.

12. The wheel according to claim 3, wherein each of said radial elements is constituted by a first and a second wire spoke having respective terminal proximal portions connected to said hub and respective terminal distal portions connected to said rim in respective pairs of said fixing seats.

13. The wheel according to claim 11, wherein first and second spoke of one radial element cross each other.

14. The wheel according to claim 12, wherein first and second spoke of one radial element cross each other.

15. The wheel according to claim 11, wherein said first and second spoke of one radial element are slightly convergent toward said couple of fixing seats.

16. The wheel according to claim 12, wherein said first and second spoke of one radial element are slightly convergent toward said couple of fixing seats.

17. The wheel according to claim 11, wherein said first and second spoke of one radial element are substantially parallel.

18. The wheel according to claim 12, wherein said first and second spoke of one radial element are substantially parallel.

19. The wheel according to claim 11, wherein said first and second spoke of one radial element are slightly divergent toward said couple of fixing seats.

20. The wheel according to claim 12, wherein said first and second spoke of one radial element are slightly divergent toward said couple of fixing seats.
